(19) United States
(12) Patent Application Publication
(10) Pub. No.: US 2010/0024159 A1
(43) Pub. Date: Feb. 4, 2010

(54) Unburied Hydraulic Door Hinge System

(76) Inventors: Se Jin Oh, Kimhae-city (KR); Gum Sung Oh, Kimhae-city (KR)

Correspondence Address: PARK LAW FIRM, 3255 WILSHIRE BLVD, SUITE 1110, LOS ANGELES, CA, 90010, US

(21) Appl. No.: 12/211,776

(22) Filed: Sep. 16, 2008

(30) Foreign Application Priority Data
Sep. 17, 2007 (KR) 10-2007-0094024

(51) Int. Cl. E05F 3/20

(52) U.S. Cl. 16/54

(57) ABSTRACT

An unburied hydraulic door hinge system for automatically closing a door is directly mounted on a bottom corner of a door. Since the unburied hydraulic hinge system can be installed on the bottom corner of the door, it does not damage the aesthetic appearance of a transparent glass door such as a reinforced glass door, and is very easy to install and repair because it is not buried. From the maintenance point of view, the worker can easily gain access thereto because the split-type mounting plates can be quickly and easily separated. A hydraulic cylinder and a rotating drive mechanism, having a simplified structure and operation, not only improve the durability and lifespan of the hydraulic hinge system but also provide the possibility of mass production as well as production cost saving. Consequently, the hydraulic door hinge system has high economical efficiency.

### BACKGROUND OF THE INVENTION

1. Field of the Invention

The present invention relates to a hydraulic hinge system for an automatically closing door, and more particularly, to an unburied hydraulic door hinge system directly mounted on the automatic closing door, wherein the opened door is automatically closed by the hydraulic expansion of a hydraulic cylinder, caused by a mounting plate installed at the bottom corner of the door, as well as by the compressive action of the hydraulic cylinder in the hinge system according to the status of the opened door.

2. Description of the Related Art

When a door is left open after a passerby has passed through it, lots of energy loss would occur as a result of the wasted work of an air-conditioning/heating system of a room, and indoor environments can be made inferior due to the inflow of polluted air or dust from the outside.

A hydraulic hinge for an automatic closing door has been developed and installed to solve these kinds of shortcomings.

In the automatically closing door with the conventional hydraulic hinge of the related art, the door frame for the glass insertion is coupled with the hinge inside of the outer frame. A normal hinge configured with the pins is installed on the upper part of the door frame and a hydraulic hinge buried beneath the floor is formed on the lower part of the door frame.

The above mentioned hydraulic hinge includes a hinge axle formed therein with some protruding parts on one side of a housing which form the exterior appearance; a piston movably coupled in the housing in order to meet the hinge axle; a spring installed in the housing for providing elasticity to the piston; an oil control bar coupled to the piston for controlling the oil volume; and a piston housing in order to guide the piston. It is general to secure a space by digging the floor beneath the door and install the hydraulic hinge by burying it in the created space.

However, in the conventional automatic closing door formed with the above mentioned figures, there is a problem in that the installation of the automatic closing door is annoying because the space for the hydraulic hinge needs to be secured first on the floor where the door will be installed before the hydraulic hinge can be installed therein.

Moreover, the structure of the conventional automatic closing door is complicated since the hydraulic hinge and the cylinder are formed outside of the frame. And the maintenance/repair work is difficult to do because the cylinder works separately from the door.

Especially, the automatically closing door with the conventional hydraulic hinge of the related art is uneconomical since the maintenance/repair job costs a lot to perform because of the vulnerable structural strength and durability resulting from the use of the loose spring of the hinge and the leakage of the oil pressure and the like, according to the increasing opening/closing of the door.

Consequently, Korean Patent Application No. 2005-0014975 (Publication No. 2006-0093868) discloses an automatically closing door, in which a hinge and a cylinder are inserted into a frame formed on the bottom of the door, and are designed to rotate together with the rotation of a door so that they are easy to maintain/repair owing to the simple design. The automatic closing door can be easily installed and increased structural strength and durability has been introduced by minimizing a portion of the hydraulic hinge under the pressure.

However, in the automatic closing door with the hydraulic hinge as above mentioned, the frame for the insertion of the hydraulic hinge is designed to be necessarily installed on the whole bottom portion of the door. When it needs to be installed on a generally used reinforced glass door, the esthetic appearance of the reinforced glass door is sharply declined and the elegant design is damaged due to the base frame being installed with the hydraulic hinge.

Because the whole bottom portion of the general door needs to be cut to install the base frame formed with the hydraulic hinge, the use of the standardized door is not possible and it is highly inefficient from the general-purpose and production points of view.

In the automatic closing door with the frame for the insertion of the hydraulic hinge as above mentioned, when the hydraulic hinge is not working properly or needs to be repaired for the maintenance, it is very difficult for the workman to gain access thereto since the cylinder member and drive member of the hydraulic hinge system should be disassembled and repaired only after the whole base frame has been removed from the door.

Further, since the hydraulic cylinder, the hinge axle member interlocked with the hydraulic cylinder, and the drive members are linked in a complicated manner with so many complex parts, they are the main causes of increased production cost together with the associated economic burden from the high production cost, and inefficiency of the mass production. Its durability is too short because the risks of malfunction or breakdown can be increased due to the many numbers of linked parts as well as the decreased easy assemblability of them.

### SUMMARY OF THE INVENTION

The present invention has been made to solve the above mentioned problems occurring in the prior art, and embodiments of the present invention provide a hydraulic hinge finitely coupled with a bottom corner of a door. Because the hydraulic hinge system is installed by the proximity action of both mounting plates without direct contact with the door, the installation/disassembly of the system is easy and the problems of the conventional hydraulic hinge system of the related art have been solved by providing a simple configuration and working relation of a cylinder, plus a rotating drive mechanism in order to improve the productivity and durability.

According to an aspect of the present invention, the hydraulic hinge includes split-type mounting plates coupled with the door; coupling means to couple the mounting plates with the door; a hydraulic cylinder inserted into the one side bottom of the panel; and a rotating drive mechanism including a hinge pin and an eccentric cam in order to actuate the hydraulic cylinder according to the turning angle of the door by linking with the hydraulic cylinder.

Since the mounting plates with the rotating drive mechanism and the hydraulic cylinder installed therein are mounted on the bottom corner of the door, the opened door can be automatically closed with the return of the compressed cylinder which was compressed when the door was open.

Since the unburied hydraulic hinge system with the above mentioned figures in accordance with the present invention is formed on the bottom corner of the door, it does not damage the aesthetic appearance of a transparent glass door such as a reinforced glass door and is very easy to install and repair because it is not buried. From the maintenance point of view, the user can easily access it because the split-type mounting plates can be fast and easily separated. The hydraulic cylinder and the rotating drive mechanism, having a simplified structure and operation, not only improve the durability and the lifespan of the hydraulic hinge system but also provide the possibility of mass production as well as production cost saving. Consequently, the present invention has high economic efficiency.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is an exploded diagram of a hydraulic hinge system in accordance with the present invention;

FIG. 2 is a cross-sectional view showing a bottom corner of a door with the hydraulic hinge system in accordance with the present invention;

FIG. 3 is a cross-sectional view showing the hydraulic hinge system in accordance with the present invention;

FIG. 4 is an enlarged cross-sectional view showing the bottom portion of the hydraulic hinge system in accordance with the present invention;

FIG. 5 is a cross-sectional view showing the bottom portion of the hydraulic hinge system when the door is in an open state in accordance with the present invention;

FIG. 6 is a perspective view showing the exemplary door equipped with the hydraulic hinge system in accordance with the present invention; and

FIG. 7 is an exploded diagram of the hydraulic hinge system showing how the cover can be used in accordance with the present invention.

### DETAILED DESCRIPTION OF THE INVENTION

Reference will now be made in greater detail to an exemplary embodiment of the invention, which is illustrated in the accompanying drawings.

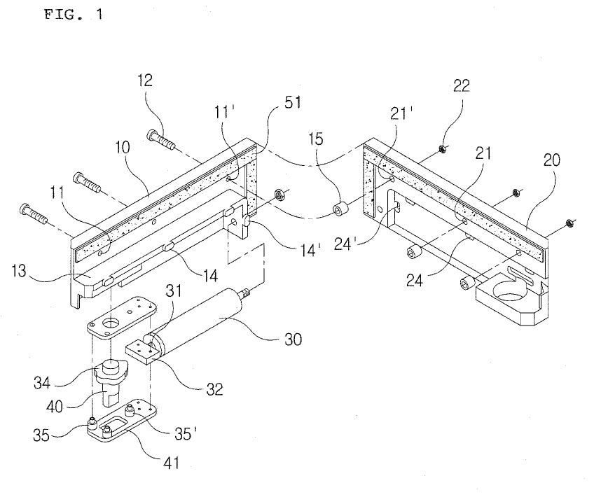

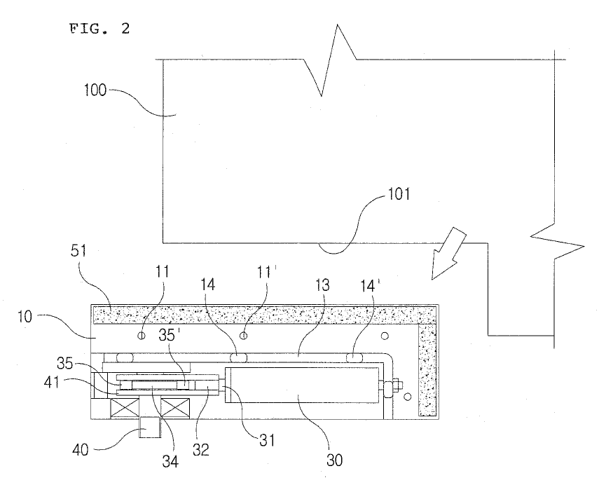

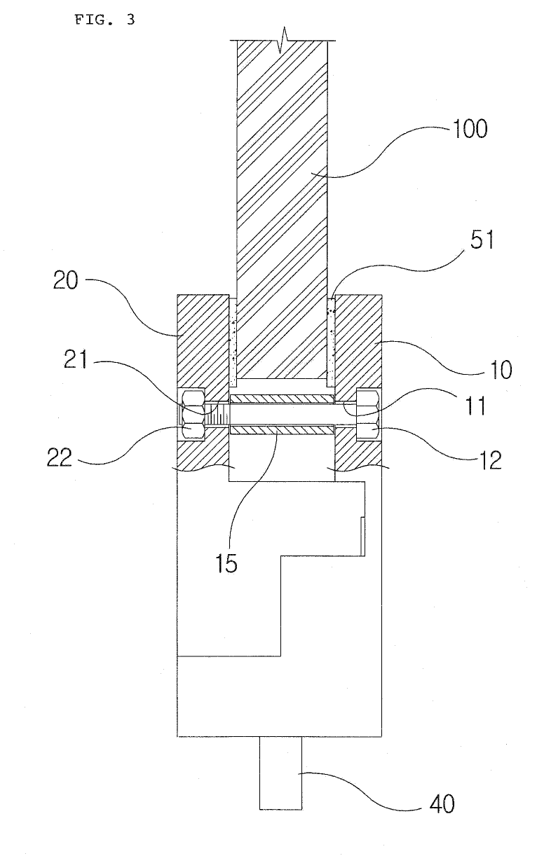

FIG. 1 is an exploded diagram of the hydraulic hinge system in accordance with the present invention; FIG. 2 is a cross-sectional view showing a bottom corner of a door with the hydraulic hinge system in accordance with the present invention; and FIG. 3 is a cross-sectional view showing the hydraulic hinge system in accordance with the present invention.

As illustrated in the drawings, a hydraulic hinge system in accordance with the present invention can be installed on one bottom corner of a general door by coupling a first mounting plate 10 with a second mounting plate 20, which are of the split-type, and a carved portion needs to be formed at the bottom corner of the door 100 where the hydraulic hinge system will be installed. In the prior art, a frame structure was formed by cutting the whole bottom portion of the door. However, the hydraulic hinge system in accordance with the present invention can be firmly installed by forming a carved corner portion 101 through cutting the small bottom corner of the door 100.

When the first mounting plate 10 and the second mounting plate 20 are assembled by facing each other on the carved corner portion 101 after forming the carved corner portion 101 on the bottom of the door 100 first, the outer corners and the bottoms of the first mounting plate 10 and the second mounting plate 20 form natural straight lines by continuously connecting with the original bottom corner and the bottom of the door 100.

In the first mounting plate 10, a plurality of bolt holes 11 and 11′ are formed and nut holes 21 and 21′ corresponding to the bolt holes 11 and 11′ are formed in the second mounting plate 20. The split-type first mounting plate 10 and second mounting plate 20 can be firmly coupled on the bottom corner of the door 100 by fastening a lock bolt 12 and a lock nut 22 using the bolt holes 11 and 11′ and nut holes 21 and 21′.

At this time, the first mounting plate 10 and the second mounting plate 20 are not directly contacting the door 100. Instead, the first mounting plate 10 and the second mounting plate 20 are coupled with each other with the door 100 inserted into the gap between the facing inside walls of the first mounting plate 10 and the second mounting plate 20. The mounting plates and the door will be firmly kept in place using the gap between the mounting plates, which is narrowed by firmly assembling the lock bolt 12 and the lock nut 22.

A space bushing 15 is fitted on the lock bolt 12 in order not to put too much pressure on the door 100 by narrowing the gap between the first mounting plate 10 and the second mounting plate 20, and the length of the space bushing 15 is a little shorter than the thickness of the door 100.

By attaching a cushion member 51, such as sponge, textile, rubber, or silicon, to the facing inside walls of the first mounting plate 10 and the second mounting plate 20, the first mounting plate 10 and the second mounting plate 20 formed with a hard material like metal will not be in direct contact with the door 100 made of the glass and the like. Besides, the hinge system according to the present invention and the door can be more firmly coupled with each other because of the slide-resistant cushion member 51.

A bend-type protrusion portion 13, being the same as the shape of the carved corner portion 101 of the door 100, is formed on the inside wall of the above mentioned first mounting plate 10, and locking pins 14 and 14′ are formed in the protrusion portion 13. In the second mounting plate 20, locking holes 24 and 24′ corresponding to the locking pins 14 and 14′ are formed. The split-type first mounting plate 10 and the second mounting plate 20 always can be coupled in the right position by inserting the locking pins 14 and 14′ into the locking holes 24 and 24′, respectively.

Of special note, there is formed a hydraulic cylinder 30 on the bottom of the first mounting plate 10. The hydraulic cylinder 30 saves the pressure of the fluid upon the door opening and returns the door to the original state by the pressure of the cylinder fluid when the artificial power is removed. And the returning power automatically forces the opened door to return to the original closed state.

In a sliding shaft 31 of the hydraulic cylinder 30, a movable plate 41 is coupled and the rollers 35 and 35′ fixed on the movable plate 41 will interfere with an eccentric cam 34 formed on the hinge shaft 40.

A separately fixed plate 32 is projected at the end of the sliding shaft 31 of the hydraulic cylinder 30 and movable plates 41 are mounted on the fixed plate 32. The movable plates 41 are vertically spaced apart and are distinct from each other. Separately located rollers 35 and 35′ are rotatably installed between the top and bottom movable plates 41, and the hinge shaft 40 having the eccentric cam 34 is installed between the rollers 35 and 35′.

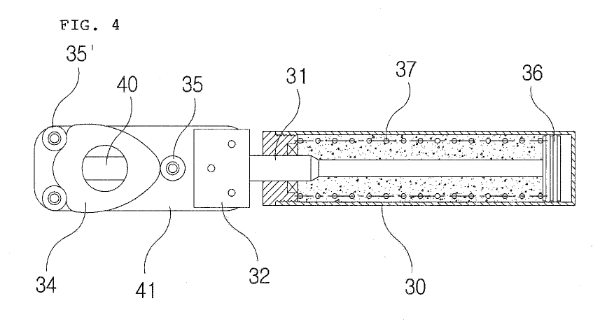

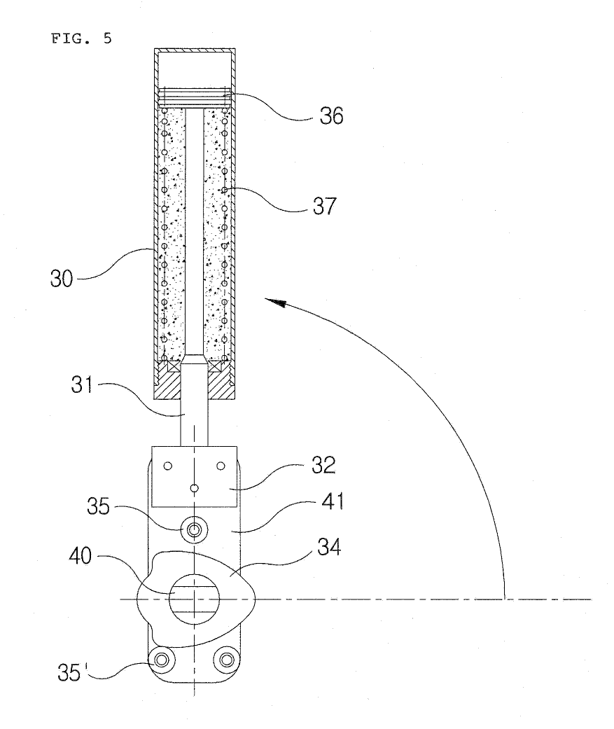

After the hinge shaft 40 and a base plate 110 installed on the floor are locked and coupled in accordance with the present invention, the door 100 formed via the hinge system looks like a closed door, as shown in FIG. 4, with a horizontal direction in the bottom plan view. When the above mentioned door 100 is opened as shown in FIG. 5, the rollers 35 and 35′, interfering with the eccentric cam 34, slidably rotate along the eccentric cam 34, and at the same time, the sliding shaft 31 and the movable plate 41 coupled with the rollers 35 and 35′ are caused to move.

When the sliding shaft 31 is moved, the fluid inside the hydraulic cylinder 30 is pressed by a piston 36, containing the pressure of the fluid therein, and the pressed spring 37 in the hydraulic cylinder 30 also comes into a compressed state.

In such a situation, when the artificial power used for opening the door 100 is removed, the pressed fluid and the spring 37 return to their original positions while returning the moved sliding shaft 31 and the movable plate 41 to the original position. By this returning power, the hinge system returns to the original position by pivoting the hinge shaft 40 and this rotatory power will force the opened door to be closed automatically.

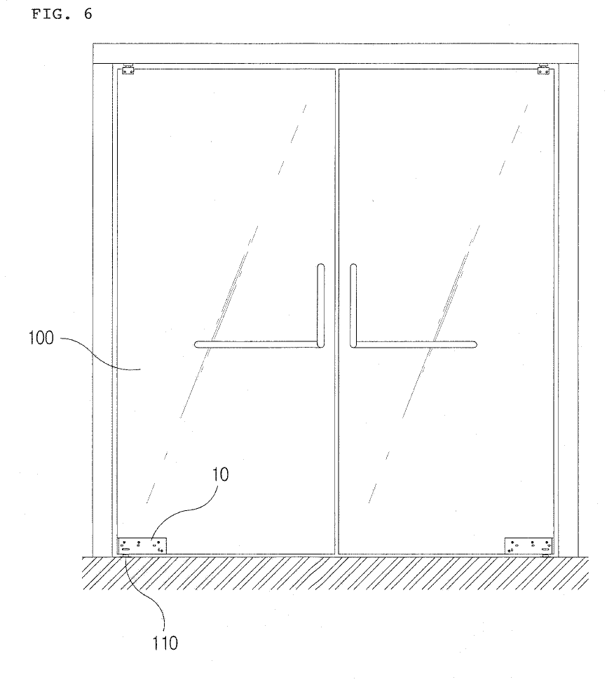

As shown in FIG. 6, the hydraulic hinge system is locally installed only at the bottom corner of the whole door. Therefore, the hydraulic hinge system does not hurt the aesthetic appearance of the door and is very easy to install and repair because it is not buried.

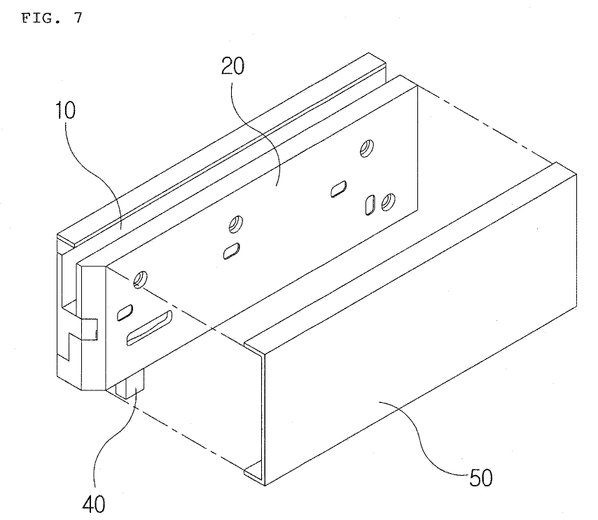

The first mounting plate 10 and the second mounting plate 20 are exposed outside and a plurality of bolt holes 11 and 11′, nut holes 21 and 21′, locking bolts 12 and locking nuts 22 are seen externally, thereby spoiling the esthetic appearance. As shown in FIG. 7, the external appearance can be improved by attaching a cover 50, made of sheet metal, fabric paper, opaque film, or leather, on the whole outside surface of the first mounting plate 10 and the second mounting plate 20.

Although the exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A hydraulic door hinge system, comprising:
split-type first and second mounting plates coupled with each other, wherein a carved corner portion of a bottom of a door is inserted into upper portions and one side portion of both the first mounting plate and the second mounting plate which face each other; and
a hydraulic cylinder inserted inside a lower portion of the first mounting plate and the second mounting plate, wherein a movable plate is coupled to one end of a sliding shaft of the hydraulic cylinder, the movable plate sliding according to a turning angle of a hinge shaft,
wherein the hydraulic cylinder is pressed in an opened state of the door by coupling a hinge shaft with a base plate and the opened door is designed to rotate to the closing direction by a returning operation of the pressed hydraulic cylinder, whereby the hydraulic door hinge system is unburied,
wherein bolt holes are transversely formed in the first plate and nut holes corresponding to the bolt holes are formed in the second mounting plate, and the split-type first and second mounting plates are firmly coupled by a locking bolt and a locking nut which are inserted into the bolt holes and the nut holes,
wherein a space bushing is fitted on the locking bolt, between the first mounting plate and the second mounting plate, in order to prevent a gap between the first mounting plate and the second mounting plate from becoming excessively narrow resulting from excessive force being applied by the locking bolt and the locking nut, and
wherein the first mounting plate has a protrusion portion are formed on an inside surface thereof so as to keep a certain distance from the second mounting plate and locking pins formed at a certain interval on the protrusion portion, and the second mounting plate has locking holes corresponding to the locking pins, so that the first mounting plate and the second mounting plate are securely coupled to each other, guided by coupling between the locking pins and the locking holes.

2. The hydraulic door hinge system according to claim 1, further comprising separate covers, each of which is attached on an exterior surface of a respective surface of the first mounting plate and the second mounting plate.
